(19) United States
(12) Patent Application Publication
(10) Pub. No.: US 2024/0275223 A1
(43) Pub. Date: Aug. 15, 2024

(54) STATOR AND ELECTRIC MOTOR INCLUDING THE SAME

(71) Applicant: TOYOTA JIDOSHA KABUSHIKI KAISHA, Toyota-shi (JP)

(72) Inventors: Kentaro YOSHIOKA, Toyota-shi (JP); Yutaro Ikeda, Toyota-shi (JP); Yuta Narisawa, Toyota-shi (JP); Hideki Nakagawa, Toyota-shi (JP); Shogo Kajimoto, Toyota-shi (JP); Hiroaki Urano, Miyoshi-shi (JP); Yukio Tsuchiya, Toyota-shi (JP)

(73) Assignee: TOYOTA JIDOSHA KABUSHIKI KAISHA, Toyota-shi (JP)

(21) Appl. No.: 18/432,561

(22) Filed: Feb. 5, 2024

(30) Foreign Application Priority Data
Feb. 9, 2023 (JP) 2023-018190

(51) Int. Cl. H02K 1/20

(52) U.S. Cl. CPC H02K 1/20

(57) ABSTRACT

A stator for an electric motor may include a back iron having a cylindrical shape and extending along an axial direction; a plurality of teeth provided on an inner circumferential surface of the back iron; and a stator coil provided on the plurality of teeth. The back iron may be provided with a coolant passage extending along the axial direction to a first end face of the back iron. The coolant passage may include a first section extending from the first end face and a second section adjacent to the first section. A dimension of the first section of the coolant passage in a radial direction of the stator may be different from a dimension of the second section of the coolant passage in the radial direction.

### REFERENCE TO RELATED APPLICATION

This application claims priority to Japanese Patent Application No. 2023-018190 filed on Feb. 9, 2023. The entire contents of the priority application are incorporated herein by reference.

### BACKGROUND ART

The technology disclosed herein relates to a stator and an electric motor including the same.

A stator for an electric motor is described in International Publication No. 2022/195920. This stator includes a back iron having a cylindrical shape and extending along an axial direction, a plurality of teeth provided on an inner circumferential surface of the back iron, and a stator coil provided on the plurality of teeth. A plurality of coolant passages is arranged in the back iron in a circumferential direction, and the coolant passages extend along the axial direction to an end face of the back iron. A coolant flowing in the coolant passages is supplied to a coil end (an end portion of the stator coil in the axial direction) protruding from the end face of the back iron.

### SUMMARY

A stator coil is a collectivity of coil wires that form a plurality of coils, and there are spaces between the coil wires at a coil end. The density of the coil wires (simply termed “coil density” hereinafter) is not necessarily uniform over the coil end, and the coil density at the coil end varies depending particularly on the axially protruding distance from the end face of the back iron. In this case, it is effective to directly supply a coolant from a coolant passage to a part of the coil end with a high coil density in order to efficiently cool the coil end. Alternatively, a conductor (e.g., a bus bar) thicker than the coil wires may be disposed at the coil end for an electrical connection to an external. In this case, it is effective to directly supply the coolant from the coolant passage to the conductor.

As described, when the coolant is supplied from the coolant passage to the coil end, it is effective to directly supply the coolant to a specific part of the coil end in light of the cooling efficiency. To achieve this, it is conceivable to dispose a guide member at the end face of the back iron to control a coolant flow in the coolant passage. However, such addition of a guide member may cause an increased size of electric motor and increased manufacturing costs. In view of the above, the disclosure herein provides a technology for efficiently cooling a coil end with a simple configuration.

A technology disclosed herein is embodied as a stator for an electric motor. The stator may comprise a back iron having a cylindrical shape and extending along an axial direction, a plurality of teeth provided on an inner circumferential surface of the back iron, and a stator coil provided on the plurality of teeth. The back iron may be provided with a coolant passage extending along the axial direction to a first end face of the back iron. The coolant passage may comprise a first section extending from the first end face and a second section adjacent to the first section. A dimension of the first section of the coolant passage in a radial direction of the stator may be different from a dimension of the second section of the coolant passage in the radial direction.

In the configuration above, the dimension of the coolant passage in the radial direction is reduced or increased in the first section adjacent to the first end face of the back iron. If the dimension of the coolant passage in the radial direction is reduced in the first section, a coolant in the coolant passage is discharged at a high speed from the first end face of the back iron. In this case, the coolant is supplied to a part of the coil end that is far away from the first end face of the back iron. On the other hand, if the dimension of the coolant passage in the radial direction is increased in the first section, the coolant in the coolant passage is discharged at a low speed from the first end face of the back iron. In this case, the coolant is supplied to a part of the coil end that is close to the first end face of the back iron. As above, by reducing or increasing the dimension of the coolant passage in the radial direction in the first section, a part of the coil end to which the coolant is supplied can selectively be set. The coolant can be directly supplied to a specific part of the coil end, and thus the coil end can be efficiently cooled.

The length of the first section is not particularly limited. For example, the length of the first section may be extremely short such as a thickness of a single magnetic steel sheet or a plurality of magnetic steel sheets.

### BRIEF DESCRIPTION OF DRAWINGS

FIG. 1 is a schematic cross-sectional view of an electric motor 2 according to an embodiment.

FIG. 2 is a cross-sectional view along a line II-II in FIG. 1.

FIG. 3 is a partial cross-sectional view showing a stator core 12, 14 alone.

FIG. 4 shows a first section 30A and a second section 30B of a coolant passage 30.

FIG. 5 is an enlarged view of a part V in FIG. 4.

FIG. 6 shows a third section 30C and a fourth section 30D of the coolant passage 30.

FIG. 7 shows a variant of the coolant passage 30.

FIG. 8 shows a variant of the coolant passage 30.

FIG. 9 shows a variant of the coolant passage 30.

FIG. 10 shows a variant of the coolant passage 30.

FIG. 11 shows a variant of the coolant passage 30.

FIG. 12 shows a variant of the coolant passage 30.

### DETAILED DESCRIPTION

In one or more aspects of the present technology, the dimension of the first section of the coolant passage in the radial direction may be smaller than the dimension of the second section of the coolant passage in the radial direction. This configuration allows a coolant to be directly supplied to a part of the coil end that is far away from the first end face of the back iron.

In one or more aspects of the present technology, the dimension of the first section of the coolant passage in the radial direction may decrease toward the first end face. In this case, this dimension may decrease continuously or stepwise toward the first end face. This configuration allows for a reduction in pressure loss in the coolant passage. In another embodiment, the dimension of the first section in the radial direction may be constant along the axial direction.

In one or more aspects of the present technology, the coolant passage may comprise an inner surface that is located inward in the radial direction, and the inner surface may incline outward in the radial direction toward the first end face in the first section. Additionally or alternatively, the coolant passage may comprise an inner surface that is located outward in the radial direction, and the inner surface may incline inward in the radial direction toward the first end face in the first section.

In one or more aspects of the present technology, the dimension of the second section of the coolant passage in the radial direction may be constant along the axial direction. This configuration allows for a reduction in pressure loss in the second section of the coolant passage.

In one or more aspects of the present technology, the dimension of the first section of the coolant passage in the radial direction may be larger than the dimension of the second section of the coolant passage in the radial direction. This configuration allows the coolant to be directly supplied to a part of the coil end that is close to the first end face of the back iron.

In one or more aspects of the present technology, the dimension of the first section of the coolant passage in the radial direction may increase toward the first end face. This configuration allows for a reduction in pressure loss in the coolant passage. In another embodiment, the dimension of the first section in the radial direction may be constant along the axial direction.

In one or more aspects of the present technology, the coolant passage may comprise an inner surface that is located inward in the radial direction, and the inner surface may incline inward in the radial direction toward the first end face. Additionally or alternatively, the coolant passage may comprise an inner surface that is located outward in the radial direction, and the inner surface may incline outward in the radial direction toward the first end face.

In one or more aspects of the present technology, the dimension of the second section of the coolant passage in the radial direction may be constant along the axial direction. This configuration allows for a reduction in pressure loss in the second section of the coolant passage.

In one or more aspects of the present technology, the coolant passage may extend along the axial direction to a second end face of the back iron located opposite the first end face. The coolant passage may further comprise a third section extending from the second end face and a fourth section adjacent to the third section. A dimension of the third section of the coolant passage in the radial direction may be different from a dimension of the fourth section of the coolant passage in the radial direction. The structure according to the present technology is applicable to both ends of the coolant passage.

In one or more aspects of the present technology, the first section of the coolant passage and the third section of the coolant passage may be symmetric in shape in the axial direction. This configuration allows the back iron to maintain its structural symmetry and thus to maintain its symmetry of electromagnetic properties.

In one or more aspects of the present technology, the coolant passage may be formed of a through hole defined in the back iron. In another embodiment, the coolant passage may be formed of a groove defined in an outer circumferential surface of the back iron.

The technology disclosed herein is also embodied as an electric motor. The electric motor may comprise a stator and a rotor disposed within the stator. In this case, the stator may be any of the stators according to aspects disclosed herein.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved stators for electric motors and electric motors, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Referring to the drawings, a stator 10 according to an embodiment and an electric motor 2 comprising the stator 10 are described. The electric motor 2 can be used in an electric-powered vehicle as a prime mover for driving the wheel(s), but the application is not particularly limited thereto. The electric-powered vehicle herein broadly means any vehicle that includes a motor for driving at least one wheel and comprises, for example, a battery electric-powered vehicle, a hybrid electric-powered vehicle, a plug-in hybrid electric-powered vehicle, and a fuel cell electric-powered vehicle.

In the drawings, a direction X and a direction Y are horizontal directions and are perpendicular to each other, and a direction Z is a vertical direction and is perpendicular to the directions X and Y. The direction X is parallel to a center axis C of the electric motor 2 and may be referred to as an axial direction X herein. Further, in the drawings, a direction R indicates a circumferential direction R about the center axis C of the electric motor 2, and a direction S indicates a radial direction from the center axis C of the electric motor 2. Moreover, unlabeled arrows in the drawings schematically show how a coolant flows.

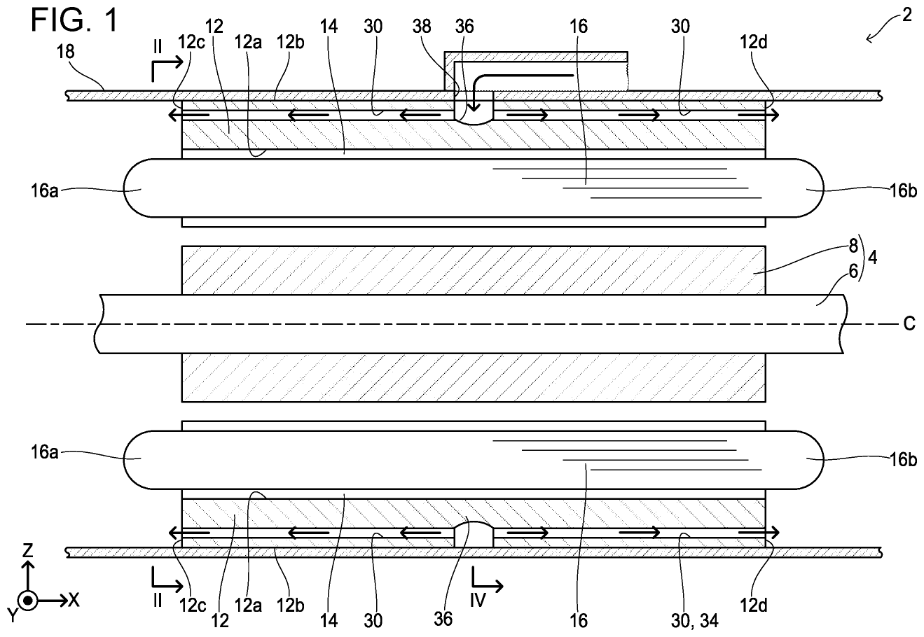

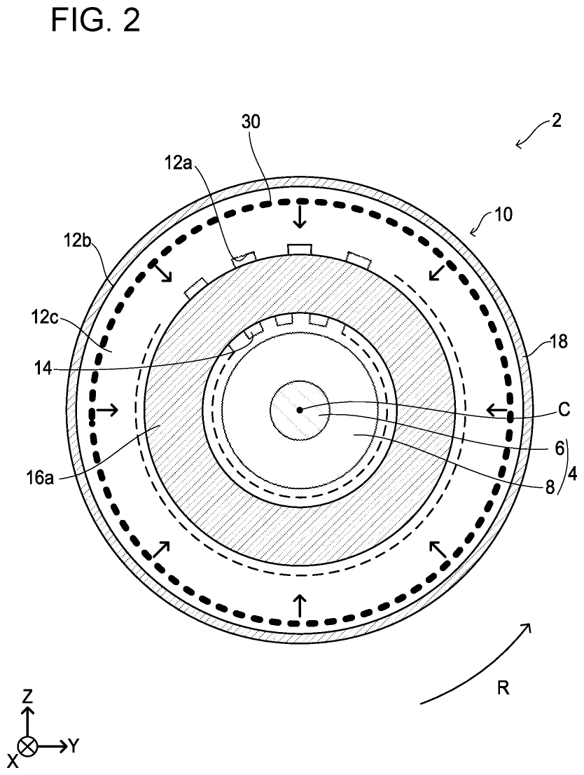

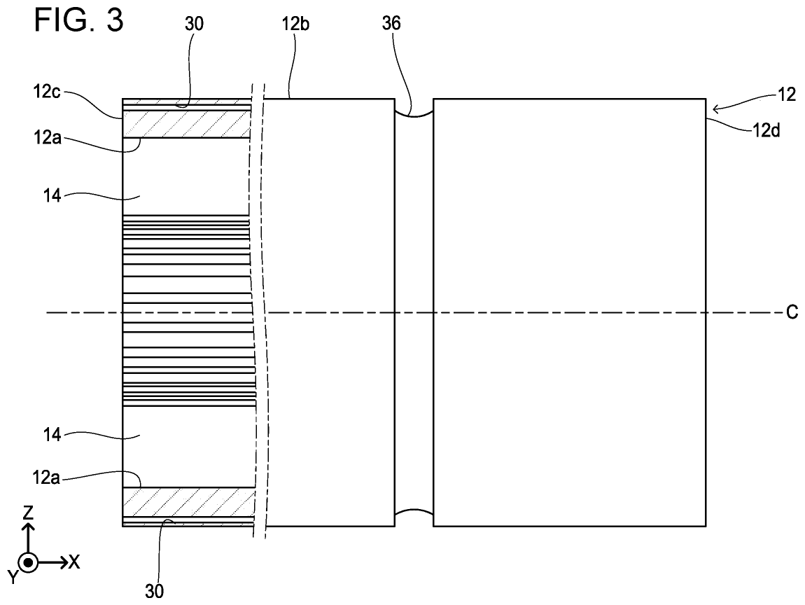

As shown in FIGS. 1 to 3, the electric motor 2 comprises a rotor 4 and the stator 10. The rotor 4 is disposed within the stator 10 and is supported rotatably about the center axis C. The rotor 4 comprises a center shaft 6 and a rotor core 8 fixed to the center shaft 6. The rotor core 8 is constituted of a soft magnetic material. The rotor core 8 in the present embodiment is formed of a stack of magnetic steel sheets, although this is merely an example. A plurality of permanent magnets (not shown) is arranged on/in the rotor core 8 along the circumferential direction R.

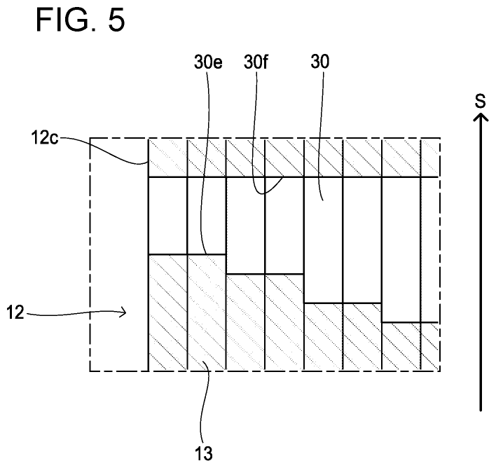

The stator 10 comprises a stator core 12, 14, a stator coil 16, and a casing 18. The stator core 12, 14 is constituted of a soft magnetic material. The stator core 12, 14 in the present embodiment is formed of a stack of magnetic steel sheets 13 (see FIG. 5), although this is merely an example. The stator core 12, 14 comprises a back iron 12 that has a cylindrical shape and extends along the axial direction X and a plurality of teeth 14 provided on an inner circumferential surface 12a of the back iron 12. The teeth 14 are equally spaced apart from each other in the circumferential direction R. Each of the teeth 14 protrudes from the inner circumferential surface 12a of the back iron 12 toward the center axis C. In some of the drawings, a part or entirety of the plurality of teeth 14 is omitted. The casing 18 is disposed to surround an outer circumferential surface 12b of the back iron 12.

The stator coil 16 is provided on the plurality of teeth 14. Although details are omitted in the drawings, the stator coil 16 is a collectivity of coil wires forming a plurality of coils. These coils are each arranged to surround corresponding one or more teeth 14. The coil wires of the stator coil 16 may be constituted of flexible wires or rigid rectangular wires. The specific structure of the stator coil 16 is not particularly limited. Both ends 16a, 16b of the stator coil 16 in the axial direction X protrude from the stator core 12, 14. In the disclosure herein, one end 16a of the stator coil 16 in the axial direction X is termed a first coil end 16a, and the other end 16b of the stator coil 16 in the axial direction X is termed a second coil end 16b.

A plurality of cooling passages 30 is defined in the back iron 12. The coolant passages 30 are arranged along the circumferential direction R near the outer circumferential surface 12b of the back iron 12. The coolant passages 30 may be disposed over the entire circumference of the back iron 12 or in partial region(s) of the back iron 12 in the circumferential direction R. Each of the coolant passages 30 extends in the axial direction X and reaches a first end face 12c and a second end face 12d of the back iron 12 in the axial direction. The specific configuration of the plurality of coolant passages 30 is not particularly limited. For example, each coolant passage 30 may have a cross-sectional shape of rectangle, circle, or another shape. The coolant passages 30 may be arranged in two or more rows along the circumferential direction R. The coolant passages 30 are passages in which a coolant flows. The coolant herein means a heat medium for cooling purposes, particularly a liquid oil.

An annular coolant passage 36 extending in the circumferential direction R is defined in the back iron 12. The annular coolant passage 36 in the present embodiment is formed of a groove defined in the outer circumferential surface 12b of the back iron 12, although this is merely an example. In another embodiment, a part or entirety of the annular coolant passage 36 may be formed of a through hole defined within the back iron 12. The annular coolant passage 36 is located at an intermediate position of the back iron 12 in the axial direction X and is connected to each of the coolant passages 30. The casing 18 includes a coolant supply hole 38 connected to the annular coolant passage 36. Thus, the coolant can be supplied from the outside of the casing 18 into the annular coolant passage 36 through the coolant supply hole 38. Once supplied into the annular coolant passage 36, the coolant flows along the annular coolant passage 36 while being supplied to each of the coolant passages 30. The coolant supply hole 38 is located vertically above the center axis C, although this is merely an example. However, in another embodiment, the coolant supply hole 38 may be located vertically below the center axis C or horizontally with respect to the center axis C.

As described above, in the stator 10 according to the present embodiment, the plurality of coolant passages 30 is provided in the back iron 12. The coolant is supplied to the plurality of coolant passages 30 from the annular coolant passage 36. The plurality of coolant passages 30 extends along the axial direction X to the first end face 12c and the second end face 12d of the back iron 12. A part of the coolant supplied into the coolant passages 30 flows toward the first end face 12c of the back iron 12, while the rest of the coolant supplied into the coolant passages 30 flows toward the second end face 12d of the back iron 12. At the first end face 12c of the back iron 12, the coolant from the coolant passages 30 is supplied to the first coil end 16a, while at the second end face 12d of the back iron 12, the coolant from the coolant passages 30 is supplied to the second coil end 16b. Thus, the first coil end 16a and the second coil end 16b are cooled by the coolant.

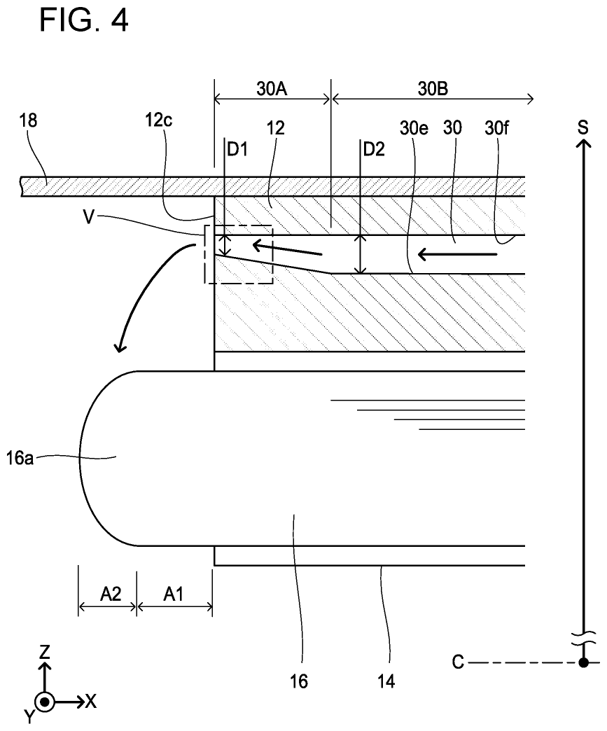

Next, referring to FIGS. 4 to 6, the coolant passages 30 are described in detail. FIGS. 4 to 6 show cross sections of one of the plurality of coolant passages 30 that is located immediately above the center axis C. The structure of coolant passage 30 to be described below may be applied to all the coolant passages 30 or only to a part of the coolant passages 30.

As shown in FIG. 4, the coolant passage 30 includes a first section 30A extending from the first end face 12c of the back iron 12 and a second section 30B adjacent to the first section 30A. The second section 30B extends to the annular coolant passage 36, although not particularly limited as such. A dimension D2 of the second section 30B of the coolant passage 30 in the radial direction S is constant along the axial direction X. A dimension D1 of the first section 30A of the coolant passage 30 in the radial direction S decreases toward the first end face 12c of the back iron 12. Thus, the dimension D1 in the radial direction S at any position of the first section 30A is smaller than the dimension D2 in the radial direction S at any position of the second section 30B. With the decreased dimension D1 of the first section 30A of the coolant passage 30 in the radial direction, the cross-sectional area of the first section 30A of the coolant passage 30 is smaller than the cross-sectional area of the second section 30B of the coolant passage 30. This allows the coolant in the coolant passage 30 to be discharged at a high speed from the first end face 12c of the back iron 12. Thus, the coolant from the coolant passage 30 is supplied to a distal portion A2 of the first coil end 16a that is far away from the first end face 12c of the back iron 12.

As described above, since the stator coil 16 is a collectivity of coil wires forming a plurality of coils, there are spaces between the coil wires at the first coil end 16a. The coil density is not uniform over the first coil end 16a, and the coil density varies depending on the protruding distance in the axial direction X from the first end face 12c of the back iron 12. Particularly, at the first coil end 16a in the present embodiment, the coil density in the distal portion A2, which is far away from the first end face 12c of the back iron 12, is larger than the coil density in a proximal portion A1 that is located closer to the first end face 12c of the back iron 12. In view of this, in the stator 10 according to the present embodiment, the dimensions D1, D2 of the coolant passage 30 in the radial direction are designed such that the coolant from the coolant passage 30 is supplied to the distal portion A2 of the first coil end 16a.

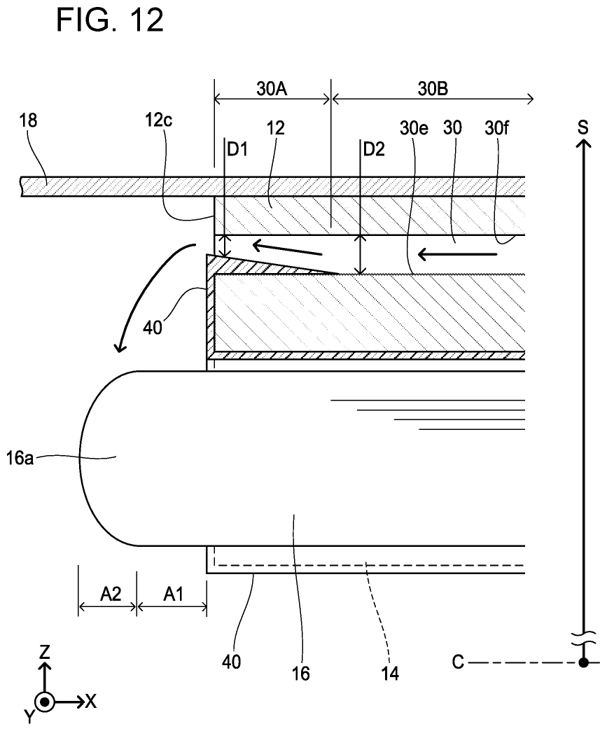

As shown in FIG. 5, in the first section 30A of the coolant passage 30, the position and size of the coolant passage 30 vary every magnetic steel sheet 13. By varying the position and size of the coolant passage 30 every magnetic steel sheet 13 or every few magnetic steel sheets 13, the dimension D1 of the coolant passage 30 in the radial direction S can be freely designed. However, in another embodiment, the dimension D1 of the coolant passage 30 can be varied by adding another member to the stator core 12, 14 (see FIG. 12). In the present embodiment, the dimension D1 of the first section 30A of the coolant passage 30 in the radial direction S continuously decreases toward the first end face 12c of the back iron 12. Contrary to this, in another embodiment, the dimension D1 in the radial direction S may decrease stepwise. Alternatively, the dimension D1 of the first section 30A in the radial direction S may be constant along the axial direction X.

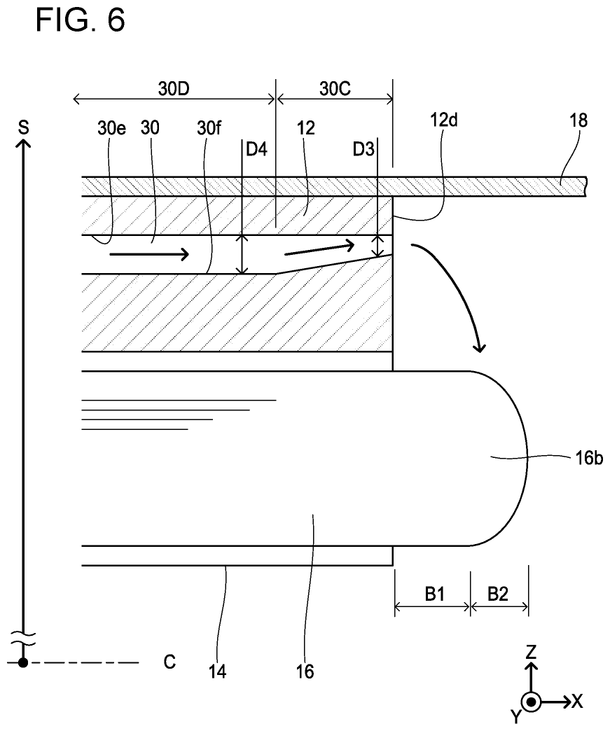

As shown in FIG. 6, the structure of the coolant passage 30 described above is also used on the second end face 12d side of the back iron 12. That is, the coolant 30 further includes a third section 30C extending from the second end face 12d of the back iron 12 and a fourth section 30D adjacent to the third section 30C. A dimension D4 of the fourth section 30D of the coolant passage 30 in the radial direction S is constant along the axial direction X. On the other hand, a dimension D3 of the third section 30C of the coolant passage 30 in the radial direction S decreases toward the second end face 12d of the back iron 12.

The third section 30C of the coolant passage 30 and the first section 30A of the coolant passage 30 are symmetric in shape in the axial direction X. Thus, at the second end face 12d of the back iron 12 as well, the coolant from the coolant passage 30 is supplied not to a proximal portion B1 of the second coil end 16b but mainly to a distal portion B2 of the second coil end 16b. However, the third section 30C of the coolant passage 30 and the first section 30A of the coolant passage 30 may be asymmetric in shape. Particularly, when the first coil end 16a and the second coil end 16b have different structures, the first section 30A and the third section 30C may be designed to have different shapes. That is, the shape of the first section 30A of the coolant passage 30 may be designed to be adapted to the structure of the first coil end 16a, and the shape of the third section 30C of the coolant passage 30 may be designed to be adapted to the structure of the second coil end 16b.

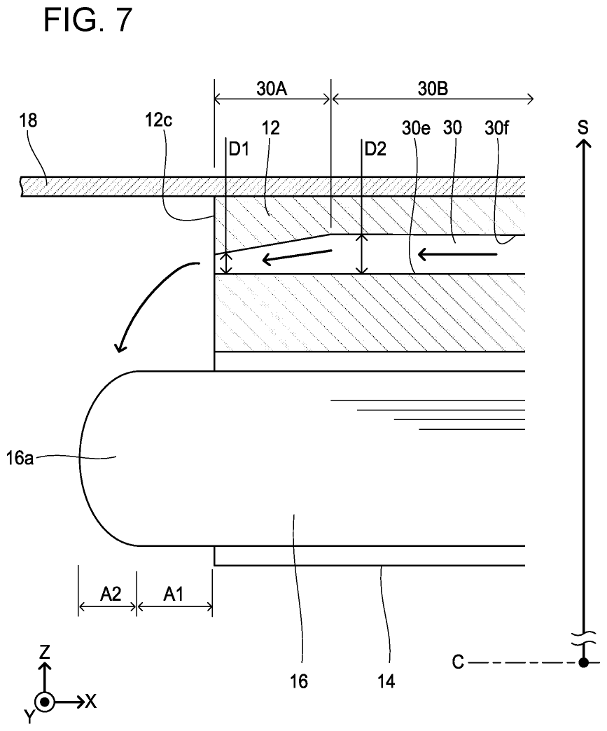

FIG. 7 shows a variant of the coolant passage 30. In the variant shown in FIG. 7, a coolant passage 30 includes a first section 30A and a second section 30B, as with the coolant passage 30 shown in FIG. 4. Then, a dimension D1 of the first section 30A in the radial direction S is smaller than a dimension D2 of the second section 30B in the radial direction S. In the coolant passage 30 shown in FIG. 4, the coolant passage 30 comprises an inner surface 30e that is located inward in the radial direction S, and the inner surface 30e inclines outward in the radial direction S toward the first end face 12c of the back iron 12 in the first section 30A. Contrary to this, in the coolant passage 30 shown in FIG. 7, the coolant passage 30 comprises an inner surface 30f that is located outward in the radial direction S, and the inner surface 30f inclines inward in the radial direction S toward the first end face 12c of the back iron 12 in the first section 30A. In this configuration as well, the cross-sectional area of the first section 30A of the coolant passage 30 is smaller than the cross-sectional area of the second section 30B of the coolant passage 30. Thus, the coolant from the coolant passage 30 is supplied to the distal portion A2 of the first coil end 16a.

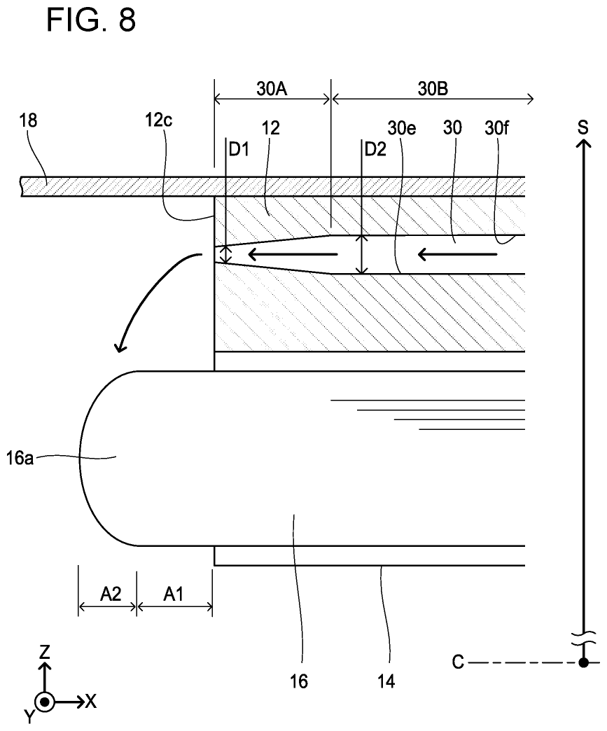

FIG. 8 shows another variant of the coolant passage 30. In the variant shown in FIG. 8, a coolant passage 30 includes a first section 30A and a second section 30B, as with the coolant passage 30 shown in FIG. 4. Then, dimension D1 of the first section 30A in the radial direction S is smaller than a dimension D2 of the second section 30B in the radial direction S. However, in the coolant passage 30 shown in FIG. 8, an inner surface 30e of the coolant passage 30 that is located inward in the radial direction S inclines outward in the radial direction S toward the first end face 12c of the back iron 12 in the first section 30A, and also an inner surface 30f of the coolant passage 30 that is located outward in the radial direction S inclines inward in the radial direction S toward the first end face 12c of the back iron 12 in the first section 30A. In this configuration as well, the cross-sectional area of the first section 30A of the coolant passage 30 is smaller than the cross-sectional area of the second section 30B of the coolant passage 30. Thus, the coolant from the coolant passage 30 is supplied to the distal portion A2 of the first coil end 16a.

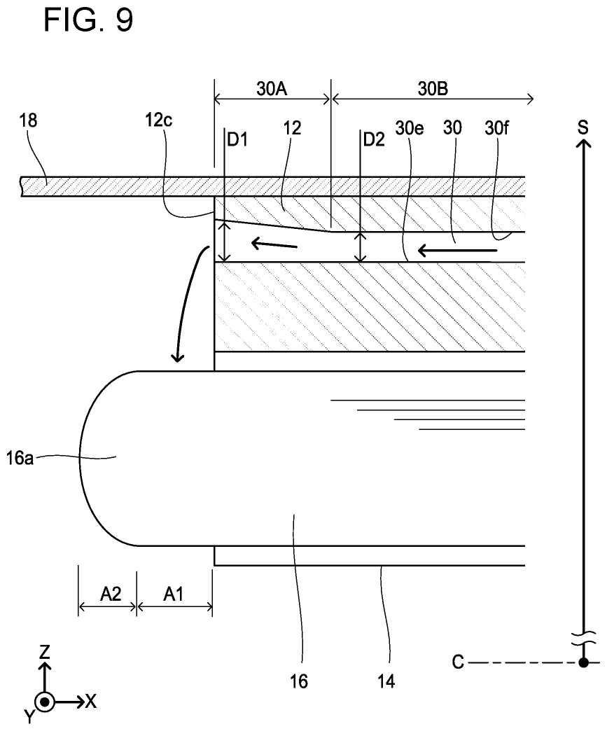

FIG. 9 shows another variant of the coolant passage 30. In the variant shown in FIG. 9 as well, a coolant passage 30 includes a first section 30A and a second section 30B. However, a dimension D1 of the first section 30A in the radial direction S is larger than a dimension D2 of the second section 30B in the radial direction S. With the increased dimension D1 of the first section 30A of the coolant passage 30 in the radial direction S, the cross-sectional area of the first section 30A of the coolant passage 30 is larger than the cross-sectional area of the second section 30B of the coolant passage 30. Thus, the coolant from the coolant passage 30 is discharged at a low speed from the first end face 12c of the back iron 12. In this case, the coolant is supplied to the proximal portion A1 of the first coil end 16a which is close from the first end face 12c of the back iron 12.

Therefore, the configuration according to the present variant is effective where the proximal portion A1 can have an increased temperature due to the structure of the first coil end 16a. For example, the coil wires may be coated by an insulation material in the proximal portion A1 of the first coil end 16a, while the coil wires may not be coated and exposed in the distal portion A2. In this case, the temperature of the proximal portion A1 may become higher than the temperature of the distal portion A2. The configuration according to the present variant can be used effectively for such a structure of the first coil end 16a, although this is merely an example.

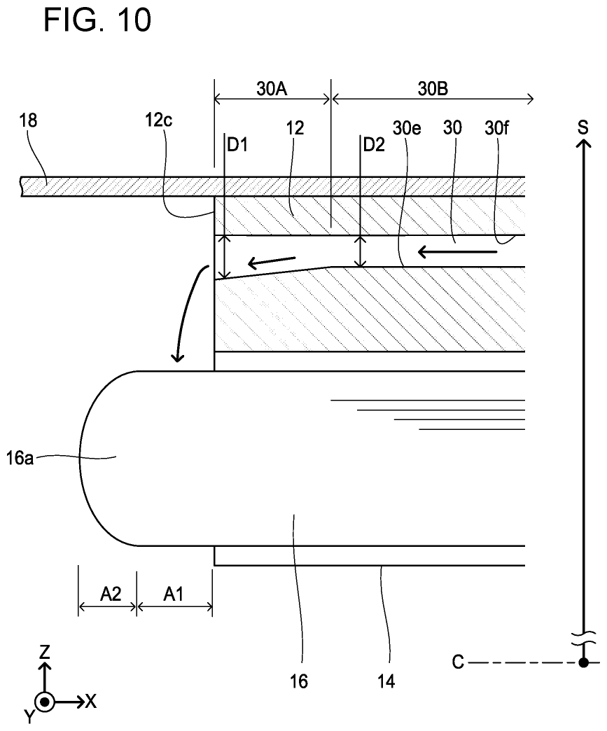

FIG. 10 shows a variant of the coolant passage 30. In the variant shown in FIG. 10, a coolant passage 30 includes a first section 30A and a second section 30B, as with the coolant passage 30 shown in FIG. 9. Then, a dimension D1 of the first section 30A in the radial direction S is larger than a dimension D2 of the second section 30B in the radial direction S. In the coolant passage 30 shown in FIG. 9, an inner surface 30f of the coolant passage 30 that is located outward in the radial direction S inclines outward in the radial direction S toward the first end face 12c of the back iron 12 in the first section 30A. Contrary to this, in the coolant passage 30 shown in FIG. 10, an inner surface 30e of the coolant passage 30 that is located inward in the radial direction S inclines inward in the radial direction S toward the first end face 12c of the back iron 12 in the first section 30A. In this configuration as well, the cross-sectional area of the first section 30A of the coolant passage 30 is larger than the cross-sectional area of the second section 30B of the coolant passage 30. Thus, the coolant from the coolant passage 30 is supplied to the proximal portion A1 of the first coil end 16a.

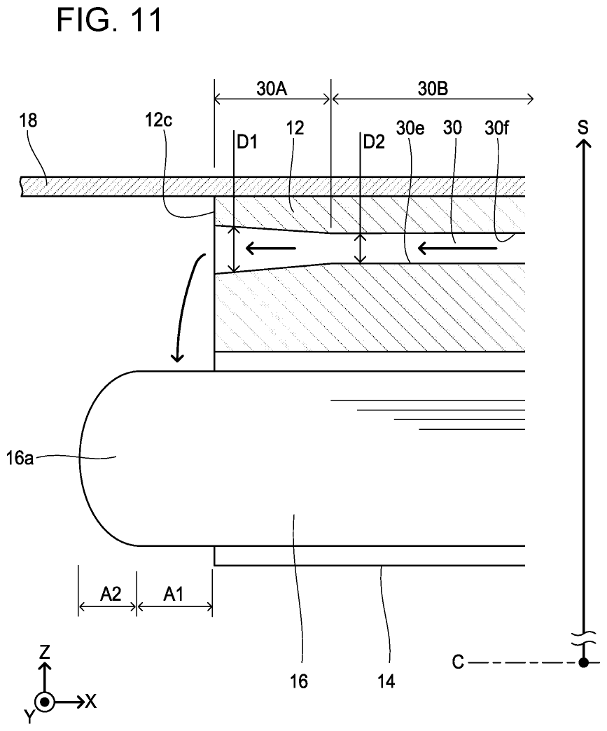

FIG. 11 shows another variant of the coolant passage 30. In the variant shown in FIG. 11, a coolant passage 30 includes a first section 30A and a second section 30B, as with the coolant passage 30 shown in FIG. 9. Then, a dimension D1 of the first section 30A in the radial direction S is larger than a dimension D2 of the second section 30B in the radial direction S. However, in the coolant passage 30 shown in FIG. 11, an inner surface 30f of the coolant passage 30 that is located outward in the radial direction S inclines outward in the radial direction S toward the first end face 12c of the back iron 12 in the first section 30A, and also an inner surface 30e of the coolant passage 30 that is located inward in the radial direction S inclines inward in the radial direction S toward the first end face 12c of the back iron 12 in the first section 30A. In this configuration as well, the cross-sectional area of the first section 30A of the coolant passage 30 is larger than the cross-sectional area of the second section 30B of the coolant passage 30. Thus, the coolant from the coolant passage 30 is supplied to the proximal portion A1 of the first coil end 16a.

FIG. 12 shows another variant of the coolant passage 30. In the variant shown in FIG. 12, a coolant passage 30 includes a first section 30A and a second section 30B, as with the coolant passage 30 shown in FIG. 4. In the coolant passage 30 shown in FIG. 12, an insulator 40 is disposed on a surface of the stator core 12, 14. The insulator 40 is constituted of an insulative material, such as a resin. The insulator 40 at least partially covers the surface of the stator core 12, 14 and electrically insulates the stator core 12, 14 from the coil 16.

A part of the insulator 40 extends from the first end face 12c of the back core 12 into the cooling passage 30. An inner surface of the coolant passage 30 in the first section 30A is covered by the insulator 40. On the other hand, the inner surface of the coolant passage 30 in the second section 30B is not covered by the insulator 40. Thus, a dimension D1 of the first section 30A of the coolant passage 30 in the radial direction S is smaller than a dimension D2 of the second section 30B of the coolant passage 30 in the radial direction S. In this way, the dimension and cross-sectional area of the coolant passage 30 may be adjusted by the insulator 40 or another member. The dimension and cross-sectional area of the coolant passage 30 can thus be changed without changing the shape of the magnetic steel sheets 13.

The insulator 40 may vary in thickness within the coolant passage 30, although not particularly limited. For example, in the variant shown in FIG. 12, the thickness of the insulator 40 located in the first section 30A of the coolant passage 30 increases toward the first end face 12c of the back iron 12. This configuration allows the dimension D1 of the first section 30A of the coolant passage 30 in the radial direction S to continuously decrease toward the first end face 12c of the back iron 12. However, in another embodiment, the thickness of the insulator 40 located in the first section 30A of the coolant passage 30 may be constant along the axial direction X.

The configuration with the insulator 40 is applicable to all the embodiments and variants described herein. That is, in all the embodiments and variants, the dimension D1 of the first section 30A and/or the dimension D2 of the second section 30B of the coolant passage 30 can be adjusted freely by using the insulator 40 or another additional member.

The configurations of the first sections 30A in the respective variants shown in FIGS. 7 to 12 can be used for third sections 30C of the coolant passages 30. In this case, the first sections 30A and the third sections 30C of the coolant passages 30 may be symmetric or asymmetric in shape in the axial direction X. Similarly, the second sections 30B and the fourth sections 30D of the coolant passages 30 may be symmetric or asymmetric in shape in the axial direction X.

In the stator 10 according to the embodiment, the plurality of coolant passages 30 is formed of a plurality of through holes defined within the back iron 12. Contrary to this, in another embodiment, a prat or all of the plurality of coolant passages 30 may be formed of one or more grooves defined in the outer circumferential surface 12b of the back iron 12. That is, a prat of all of the plurality of coolant passages 30 may be formed of spaces defined between the grooves in the back iron 12 and the casing 18. Further, the annular coolant passage 36 in the embodiment is formed of a groove defined in the outer circumferential surface 12b of the back iron 12. Contrary to this, in another embodiment, the annular coolant passage 36 may be formed of one or more through holes defined within the back iron 12. The number of the annular coolant passage 36 and the position thereof in the axial direction X are not particularly limited.

What is claimed is:

1. A stator for an electric motor, comprising:
a back iron having a cylindrical shape and extending along an axial direction;
a plurality of teeth provided on an inner circumferential surface of the back iron; and
a stator coil provided on the plurality of teeth,
wherein
the back iron is provided with a coolant passage extending along the axial direction to a first end face of the back iron,
the coolant passage comprises a first section extending from the first end face and a second section adjacent to the first section, and
a dimension of the first section of the coolant passage in a radial direction of the stator is different from a dimension of the second section of the coolant passage in the radial direction.

2. The stator according to claim 1, wherein the dimension of the first section of the coolant passage in the radial direction is smaller than the dimension of the second section of the coolant passage in the radial direction.

3. The stator according to claim 2, wherein the dimension of the first section of the coolant passage in the radial direction decreases toward the first end face.

4. The stator according to claim 3, wherein
the coolant passage comprises an inner surface that is located inward in the radial direction, and
in the first section, the inner surface inclines outward in the radial direction toward the first end face.

5. The stator according to claim 2, wherein the dimension of the second section of the coolant passage in the radial direction is constant along the axial direction.

6. The stator according claim 1, wherein the dimension of the first section of the coolant passage in the radial direction is larger than the dimension of the second section of the coolant passage in the radial direction.

7. The stator according to claim 6, wherein the dimension of the first section of the coolant passage in the radial direction increases toward the first end face.

8. The stator according to claim 7, wherein
the coolant passage comprises an inner surface that is located inward in the radial direction, and
in the first section, the inner surface inclines inward in the radial direction toward the first end face.

9. The stator according to claim 6, wherein the dimension of the second section of the coolant passage in the radial direction is constant along the axial direction.

10. The stator according to claim 1, wherein
the coolant passage extends along the axial direction to a second end face of the back iron located opposite the first end face,
the coolant passage further comprises a third section extending from the second end face and a fourth section adjacent to the third section, and
a dimension of the third section of the coolant passage in the radial direction is different from a dimension of the fourth section of the coolant passage in the radial direction.

11. The stator according to claim 10, wherein the first section of the coolant passage and the third section of the coolant passage are symmetric in shape in the axial direction.

12. The stator according to claim 1, wherein the coolant passage is formed of a through hole defined within the back iron.

13. An electric motor comprising:
the stator according to claim 1; and
a rotor disposed within the stator.
